(19) United States
(12) Patent Application Publication
(10) Pub. No.: US 2010/0152907 A1
(43) Pub. Date: Jun. 17, 2010

(54) METHOD FOR PRESSURE-SENSOR WEAR STATE DETERMINATION OF A VALVE MECHANISM

(75) Inventors: Urs E. Meier, Wuerenlingen (CH); Detlef Pape, Nussbaumen (CH)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/637,367

(22) Filed: Dec. 14, 2009

(30) Foreign Application Priority Data
Dec. 15, 2008 (DE) 10 2008 062 292.3

(51) Int. Cl. G05D 7/06; F16K 31/02; G06F 17/18

(52) U.S. Cl. 700/282; 251/129.01; 702/181; 702/183

(57) ABSTRACT

A method and a valve arrangement are disclosed for pressure-sensor diagnosis of an operating state of a valve arrangement for controlling a process medium flow, in which a valve element, which is arranged such that it can move axially within a valve housing, is moved by application of control pressure, with the control pressure being determined in the starting and/or stopped phase of the valve element in order to determine static friction. A pressure rise value of control pressure required to start movement of the valve element is measured repeatedly and successively after the movement of the valve element has been stopped. The measured pressure rise values are temporarily stored in a memory unit. A diagnosis unit accesses the pressure rise values in order to determine a probable influence of the static friction on the movement of the valve element, by statistical analysis.

### RELATED APPLICATION

This application claims priority under 35 U.S.C. §119 to German Patent Application No. 10 2008 062 292.3 filed in Germany on Dec. 15, 2008, the entire content of which is hereby incorporated by reference in its entirety.

### FIELD

The present disclosure relates to a method for pressure-sensor diagnosis of the operating state of a valve arrangement, such as a pneumatic actuating drive for controlling a process medium flow in which a valve element is arranged such that it can move axially within a valve housing by application of control pressure. Furthermore, the disclosure relates to a valve arrangement.

### BACKGROUND INFORMATION

The term “position regulator” used in this disclosure represents a mechatronic system which controls auxiliary energy of a pneumatic actuating drive on the basis of one or more input signals, in order to move a valve element to a specific position. In order to operate, the position regulator can use pressurized gas, such as compressed air, as auxiliary energy, and electrical energy as well.

Pneumatic position regulators for operation of a process valve are known. With a pneumatic system, drive chambers of a single-acting or double-acting pneumatic actuating drive can be ventilated or vented deliberately as a function of one or more input signals. The pneumatic system can include an auxiliary energy supply line, one or more pilot valve arrangements and control pressure supply lines to the drive chambers in order to control the ventilation and/or venting of the drive chambers. The movements and positions of the valve element can be represented as one or more signals with the aid of a position sensor as a position feedback sensor system. Furthermore, a control electronics system is provided which can have a microcontroller and which receives one or more input signals. Firmware can be included in the control electronics to process the input signals and the signals from the position sensor system to form output signals which are used as input signals for the pneumatic system.

Pneumatic actuating drives can be subdivided into pivoting drives and linear-movement drives. In the case of a linear-movement drive, linear movement of an output drive of the actuating drive is transmitted directly to a linearly operating actuating member. In contrast, in the case of a pivoting drive, linear movement of the output drive of the actuating drive is converted to a rotary movement.

The pneumatic actuating drive and the position regulation can be linked by a fitting kit. The fitting kit can include components which transmit the movement and position of the actuating drive with respect to the position feedback sensor system to the positioning regulator.

When using valve arrangements as disclosed herein, an entire installation or vehicle can fail in the event of an unpredicted failure of a pneumatic actuating drive. It is known to carry out a preventative replacement after an estimated life of the actuating drive has elapsed. However, when using this method, replacement can be frequently carried out well before the actual wear limit, since there is a large amount of scatter between the estimated life and the actual life.

DE 102 22 890 A1 discloses a technical solution which proposes that electronic wear state monitoring be performed. For this purpose, an electronics unit is provided to whose input side the electrical drive signal, which is predetermined by a central control unit, for a pneumatic valve is supplied, and an electrical reaction signal which follows a drive pulse initiated in this way. The electronics unit compares the time interval between the drive signal and the reaction signal of the switching delay as a measure of the wear state of the valve mechanism. The reaction signal is in this case determined by a pressure sensor which is integrated on the operating line side in the valve housing. This solution is based on the knowledge that the lengthening of the switching time of a valve over its entire operating time is directly related to the wear state. This makes it possible to use timely identification of undesirably long switching times to trigger deliberate replacement of the pneumatic valve or of its parts that are subject to wear and which would fail in a foreseeable period. This allows deliberate preventative maintenance of pneumatic installations.

The lengthening of the switching times is in this case based on an increase in the sliding friction of the valve element within the valve housing. However, in addition to such sliding friction, static friction of the switching element also has an influence, which must be overcome when the movement starts from rest immediately after the control pressure is applied. This is because the static friction and sliding friction of the valve mechanism can increase as a result of corrosion on the moving parts, or replacement of seals. This can reduce movement speed of the valve element, thus reducing the valve performance. The rise in the static friction and sliding friction may even be sufficiently great that it is no longer possible to move the valve element when the normal control pressure is applied. Measurement determination of the static friction and sliding friction changes can therefore be helpful in order to make it possible to consider preventative maintenance measures in good time, on the basis of the current operating state and wear state of the valve mechanism. The static friction and sliding friction of a valve mechanism can be based on similar phenomena and behave in a similar manner. However, the static friction can change independently of the sliding friction. In particular, a very high static friction force in comparison to the sliding friction force can adversely affect the control of a valve, and can lead to switching failure. The independent measurement detection of the static friction and the determination of static friction changes can therefore be very helpful for determining the operating state of the valve mechanism.

DE 102 09 545 A1 discloses a method for determination of the static friction of a switching element of a pneumatic valve, which can be determined during operation. In this case, the pneumatic valve is monitored during the start of the movement of the valve element, by determining the control pressure before the start of the movement and after the start of the movement. The difference between the two pressure values can be used to describe the static friction force which must be overcome when starting the valve element. In order to avoid negative influences on the measurement caused by edge effects, the starting phase can be recorded in the movement direction and in the opposite movement direction of the switching element. In addition, the difference between the pressures in the movement direction and the opposite movement direction can be used as a static friction indicator.

With this static friction determination, for correct measurement, the switching element should be held at rest by the pressure and the spring force and possible external forces. However, the switching element can be locked in the stopped position just by the static friction. The forces can be less than the maximum possible static friction forces, but these can influence the measurement. In order to start the movement of the switching element, only the difference between the actual static friction force and the maximum possible static friction force used as an additional force to overcome the static friction. The pressure difference which is measured when starting the movement of the switching element is thus reduced by the static friction force during the stopped phase, which leads to a corrupted determination of the static friction.

To avoid this influence, the linear movement and opposite linear movement of the valve element can be combined. However, this is not feasible during normal operation of the pneumatic valve. A measure such as this cannot be used to monitor the operating state during operation, because the movement of the switching element is determined by external signals, and a combination of a linear movement with a return movement directly following it occurs very rarely.

### SUMMARY

A method is disclosed for pressure-sensor diagnosis of an operating state of a valve arrangement in which a valve element is arranged to move axially within a valve housing by application of control pressure, with the control pressure being determined in a starting and/or stopped phase of the valve element in order to determine static friction of the valve element, the method comprising: measuring a pressure rise value of control pressure required to start movement of the valve element repeatedly and successively after movement of the valve element has been stopped; storing each measured pressure rise value in a memory unit; and accessing the stored pressure rise values to determine a probable influence of static friction on movement of the valve element, by statistical analysis.

A valve arrangement is disclosed for an actuating drive, comprising: a valve element arranged for movement axially within a valve housing to switch at least one control piston by application of control pressure; electronic means for measurement of the control pressure in a starting phase and a stopped phase of the valve element for determination of static friction for pressure-sensor operating state determination of the valve mechanism; a pressure sensor for repeatedly and successively measuring a pressure rise value of the control pressure required to start movement of the valve element after movement of the valve element has been stopped; a memory unit for temporarily storing each pressure rise value; and a diagnosis unit for accessing the pressure rise values to determine a probable influence of static friction on movement of the valve element, by statistical analysis.

### BRIEF DESCRIPTION OF THE DRAWINGS

Further measures will be explained in more detail in the following text together with a description of exemplary embodiments of the disclosure, on the basis of the Figures, in which:

FIG. 1 shows a schematic illustration of an exemplary valve arrangement having electronic means for pressure-sensor operating state determination of a valve mechanism; and

FIG. 2 shows an exemplary histogram illustrating distribution of measured pressures.

### DETAILED DESCRIPTION

A method is disclosed for pressure-sensor operating state determination of a valve mechanism of a pneumatic actuating drive, for example, to ensure correct determination of static friction of a valve element as an operating state indicator.

The disclosure includes the technical teaching that the pressure rise value Δp of the control pressure required to start movement of the valve element can be measured repeatedly and successively after movement of the valve element has been stopped, after which the measured pressure rise values can be temporarily stored in a memory unit, which a diagnosis unit accesses to determine the probable influence of the static friction on movement of the valve element, by statistical analysis.

Since the influence of the static friction during movement of the valve element can be a more random event, this can be determined and eliminated by static mathematical analyses. With this static analysis, noise-dependent measurement areas can be effectively reduced, and negative influences of static friction forces which have already been caused during the stopped phase can be eliminated at the same time.

In exemplary embodiments, only maximum values of a plurality of measured pressure rise values Δp of the control pressure are temporarily stored for statistical analysis, in order to use them as a static friction indicator. This is based on knowledge that the static friction force during the stopped phase of the valve element will reduce the measured static friction forces.

Additionally or as an alternative, a pressure rise value Δp of the control pressure in the movement direction can be provided with a positive mathematical sign, while in contrast a pressure rise value Δp of the control pressure in the opposite movement direction can be provided with a negative mathematical sign. The maximum value and the minimum value can then be determined therefrom, and the difference between them used as an indicator of the static friction.

In exemplary embodiments, the maximum value and the minimum value can be very sensitive to other static influences, such as electrical noise. Noise in the signal can result in higher measured values for the static friction. In this context, the scatter of the pressure rise values Δpn which can be measured repeatedly and successively can be determined in order to determine the quality of the measurement cycle for measured value correction.

In addition, to each measured pressure rise value Δp, the associated moving direction of the valve element can also be recorded and temporarily stored in the form of a data record, in order to make it possible to determine the maximum value and the minimum value subsequently, as described above. This can simplify the corresponding association of the linear movement and the opposite linear movement of the valve element. The average can be formed for each data record, and a difference between the averages can be used to determine the static friction.

In alternative mebodiments, a distribution of the measured pressure rise values Δpn can be represented visually on a histogram. The minimum values and maximum values, as well as the average values, can be determined in the same way as the scatter by means of the histogram. If the measurement data relating to the average and scatter values is evaluated, then there is no need to temporarily store the measured pressure rise values in the original form. This can offer an advantage that only a reduced data record need be stored. As a result of this measure, the memory unit which is connected to the diagnosis unit for statistical analysis can be designed and/or configured to have quite a small memory capacity.

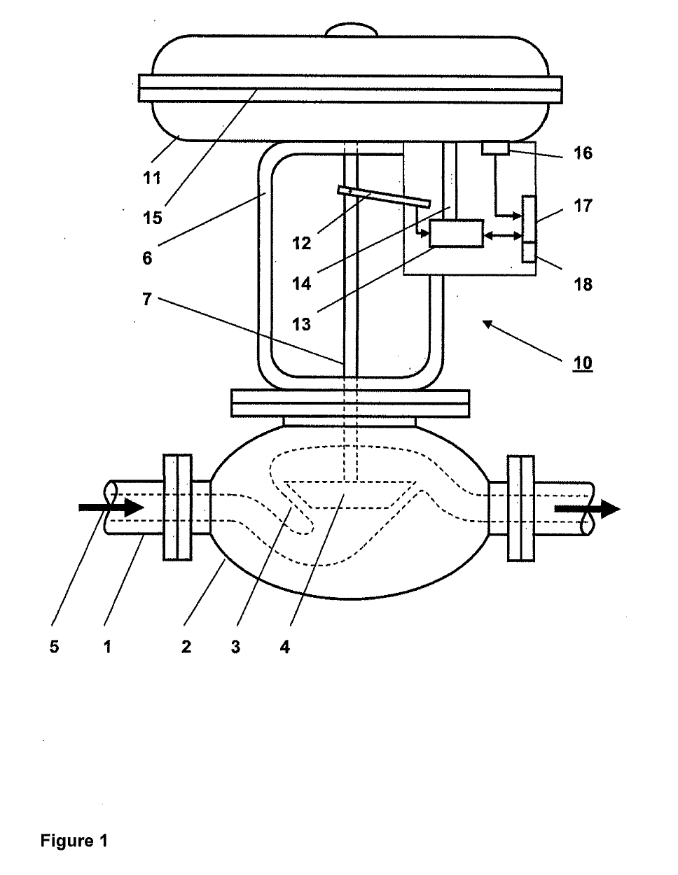

As shown in FIG. 1, an exemplary valve housing 2 of a process valve is installed in a pipeline 1 of a process installation. In its interior, this valve housing 2 has a closure body 4, which interacts with a valve seat 3, in order to control the amount of process medium 5 passing through. The closure body 4 is operated linearly by a pneumatic actuating drive 10 via a pushrod 7. The pneumatic actuating drive 10 is connected via a yoke 6 to the valve housing 2 of the process valve. A digital position regulator with positioning regulation 13 is fitted to the yoke 6. The travel of the pushrod 7 into the area of the position regulator is signaled via a position sensor 12. The detected travel is compared with a predetermined nominal value within the positioning regulation 13, and the pneumatic actuating drive 10 is operated as a function of the determined regulation discrepancy. The pneumatic actuating drive 10 includes a pilot valve arrangement in the area of the positioning regulation 13, in order to convert the electrical regulation signal of the determined regulation discrepancy to an adequate control pressure. The control pressure is passed via a pressure medium supply 14 to a drive chamber 11 of the pneumatic actuating drive 10.

A membrane-like control piston 15 (which cannot be seen from the outside) is integrated within the drive chamber 11, and operates the pushrod 7.

The pressure within the drive chamber 11 can be measured by means of a pressure sensor 16 which is likewise associated with the pneumatic actuating drive 10. In order to determine the operating state of the valve mechanism using pressure sensors, the pressure sensor 16 can repeatedly and successively measure the pressure rise value Δp of the control pressure which is required to start the movement of the valve element 4 after the movement of the valve element 4 has been stopped. The measured values determined in this way can be preprocessed by a diagnosis unit 17 and stored in a downstream memory unit 18. The statistical probable influence of the static friction on the movement of the valve element 4 can be determined by statistical analysis by the diagnosis unit 17, using the measured values stored in the memory unit 18.

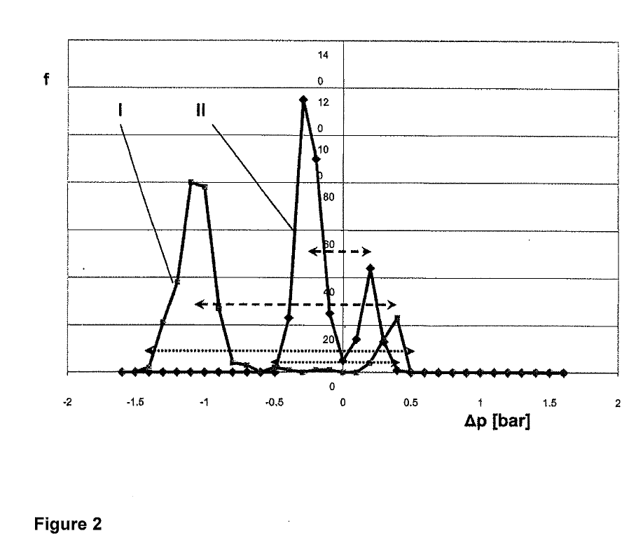

FIG. 2 shows an exemplary histogram of the distribution of measured pressure rise values Δp for this purpose. The pressure rise values Δp are in this case plotted on the horizontal axis, with positive values indicating a movement direction of the switching element, while in contrast negative values indicate the opposite movement direction of the switching element. The frequency with which the measured values occur is plotted on the vertical axis.

The graph I has its maximum at a pressure difference of about −1.2 bar, from which it is possible to state that a maximum control pressure such as this, which indicates the static friction, can be applied very frequently in the opposite movement direction, in order to cause the switching element to move.

In contrast, the graph II has its maximum at a pressure difference Δp of only about −0.4 bar, from which it can be stated that only a very small amount of static friction need most frequently be overcome during switching of the valve. This also applies to the movement direction of the valve, where the pressure difference is most frequently likewise very low, at about 0.2 bar.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Valve housing
3 Valve seat
4 Closure body
5 Process medium
6 Yoke
7 Pushrod
10 Actuating drive
11 Drive chamber
12 Position sensor
13 Positioning regulation
14 Pressure medium supply (from the pilot valve)
15 Control piston
16 Pressure sensor
17 Diagnosis unit
18 Memory unit
Δp Pressure rise value

What is claimed is:

1. A method for pressure-sensor diagnosis of an operating state of a valve arrangement in which a valve element is arranged to move axially within a valve housing by application of control pressure, with the control pressure being determined in a starting and/or stopped phase of the valve element in order to determine static friction of the valve element, the method comprising:
measuring a pressure rise value of control pressure required to start movement of the valve element repeatedly and successively after movement of the valve element has been stopped;
storing each measured pressure rise value in a memory unit; and
accessing the stored pressure rise values to determine a probable influence of static friction on movement of the valve element, by statistical analysis.

2. The method as claimed in claim 1, wherein only maximum values of plural measured pressure rise values of the control pressure are temporarily stored for statistical analysis.

3. The method as claimed in claim 1, wherein a pressure rise value of the control pressure in a movement direction is provided with a positive mathematical sign, while a pressure rise value of the control pressure in an opposite movement direction is provided with a negative mathematical sign, the method comprising:
determining a maximum value and a minimum value from the control pressure provided with a positive sign and/or the control pressure provided with a negative sign; and
indicating static friction using a difference between the maximum value and the minimum value.

4. The method as claimed in claim 1, comprising:
determining a scatter of the stored pressure rise values which are measured repeatedly and successively to determine a quality of a measurement cycle for measured value correction.

5. The method as claimed in claim 1, comprising:
recording and temporarily storing an associated moving direction of the valve element as a data record.

6. The method as claimed in claim 1, comprising:
representing a distribution of the pressure rise values on a histogram.

7. A valve arrangement for an actuating drive, comprising:
a valve element arranged for movement axially within a valve housing to switch at least one control piston by application of control pressure;
electronic means for measurement of the control pressure in a starting phase and a stopped phase of the valve element for determination of static friction for pressure-sensor operating state determination of the valve mechanism;
a pressure sensor for repeatedly and successively measuring a pressure rise value of the control pressure required to start movement of the valve element after movement of the valve element has been stopped;
a memory unit for temporarily storing each pressure rise value; and
a diagnosis unit for accessing the pressure rise values to determine a probable influence of static friction on movement of the valve element, by statistical analysis.

8. The valve arrangement as claimed in claim 7, comprising:
a display connected with the diagnosis unit for graphic display of a distribution of the measured pressure rise values on a histogram.

9. The method as claimed in claim 1, comprising:
controlling a process medium flow with the diagnosis.
